(19) United States
(12) Patent Application Publication
(10) Pub. No.: US 2013/0305845 A1
(43) Pub. Date: Nov. 21, 2013

(54) Water sampling mechanism

(71) Applicant: Christopher Rod, Tucson, AZ (US)

(72) Inventor: Christopher Rod, Tucson, AZ (US)

(21) Appl. No.: 13/506,874

(22) Filed: May 21, 2012

(51) Int. Cl. G01N 1/12

(52) U.S. Cl. 73/864.63

(57) ABSTRACT

A water sampling assembly which utilizes a clear container. The clear container is connected to a generally circular lip portion via a shoulder portion. The lip portion has an open distal edge and being threaded on an exterior surface. The diameter of the main body is than the diameter of the lip portion. Contained with the main body is a spherical stopper mechanism which rises as water enters the main body until such time that the spherical stopper seals the shoulder/lip portion so that further water is discouraged from entering the main body of the clear container. Ideally a cap mechanism is provided that is securable to the lip portion via threads so that the entire assembly, with the collected water sample, is easily transported and stored.

### BACKGROUND OF THE INVENTION

This invention relates generally to sampling mechanisms and more particularly to a sampling mechanism for runoff water.

In the United States there is a pronounce effort to preserve the quality of the water sources. In this regard, contaminates are monitored so that remedial steps can be taken before a major environmental problem is created. These monitoring steps, and the resultant sanctions, are codified in the United States Code under 33 USC 1251-1387.

Contained within these requirements is the requirement that commercial sites monitor the run-off water to ascertain if any pollutants are being carried off site. Depending on the applicable law, samples of the run-off must be taken at least twice a year and the initial flow (in the first thirty minutes) is collected and then evaluated. As can be imagined, often it is difficult if not practically impossible to arrange to collect the initial run-off due to the site's location or the occurrence of the precipitation during the night, weekends, or holidays.

For this reason, effective monitoring has become a hit or miss proposition, yet the law requires sampling to be done.

Further, in many situations, although not required by law, the owner of the property desires to test and catalog runoff water to assure that the run off does not generate any legal problems with neighboring properties, ground water, or neighboring municipalities. This is done for a variety of reasons such as to prepare a “paper trail” for potential civil litigation from neighboring properties for protection from civil municipalities that suspect their property or water sources have been contaminated by the runoff.

One such device which is used to collect water for sampling is described in U.S. Pat. No. 8,109,158, entitled “Sampling Apparatus” issued to Guieze et al. on Feb. 7, 2012, incorporated hereinto by reference.

Once samples have been taken, there are a variety of testing or evaluating processes which can be employed and are obvious to those of ordinary skill in the art. Examples of the such testing procedures/systems is described in: U.S. Pat. No. 8,106,155, entitled “Test Kit for Determining Process for Determinign Antibiotics Containing a Beta-Lactam Ring in a Biological Fluid” issued to Degelaen et al. on Jan. 31, 2012; U.S. Pat. No. 8,117,019, entitled “Method for Evaluating Sedimentary Basin Properties by Numerical Modeling of Sedimentation Process” issued to Sun et al. on Feb. 14, 2012; and, U.S. Pat. No. 8,115,930, entitled “Methods and Apparatus for Analyzing Samples and Collecting Sample Fractions” issued to Anderson, Jr. et al. on Feb. 14, 2012; all of which are incorporated hereinto by referece.

Unfortunately, these systems are complex in nature and do not assist with periodic sampling which is required in many situations.

It is clear there is a need for an effective mechanism to sample first runoff water.

### SUMMARY OF THE INVENTION

The invention provides a water sampling assembly which utilizes a clear container. By being clear, the collected sample is visually analyzed for suspended materials which had been carried in the runoff. Often, the collected sample is first visually analyzed and then subjected to chemical analysis for further screening. The visual assessment includes color, clarity, foam sheen, solids, and other matters of concern.

Because the container is clear, photo records are easily taken and stored in digital form or transferred to a governing body for their assessment.

The main body of clear container is connected to a generally circular lip portion via a shoulder portion. The shoulder is sloped and generally uniform for purposes as will be clear later.

The diameter of the main body is greater than the diameter of the lip portion. In the preferred embodiment, the clear container's diameter is approximately twenty percent greater than the diameter of the lip portion.

The lip portion has an open distal edge. The water to be sampled flows through the open end via the open distal edge and is collected inside the main body. The lip portion is threaded on an exterior surface which allows a cap to be secured once the water has been collected.

Ideally, the opening for the container is positioned above the ground level (ideally a half of an inch) so that the water flow is captured, not the moving bed sediment.

A spherical stopper mechanism is contained within the main body. As the sample water is collected, the spherical stopper mechanism rises with the water level until such time that the spherical stopper mechanism engages the collar and substantially seals therewith to prevent, or curtail, further water sample from flowing into the main body of the clear container.

The use of the spherical stopper mechanism provides that the initial runoff is collected and is not disturbed or modified by a later flow.

Ideally a cap mechanism is provided that is securable to the lip portion via threads so that the entire assembly, with the collected water sample, is easily transported to a laboratory or stored for later analysis or as a record of the runoff quality.

One embodiment of the invention employs a lid portion that is open at its center (forming a doughnut shape). In this embodiment, either a solid plate may be used to completely the seal the assembly (typically after the water sample has been taken), or a screen which allows the water to flow into the clear container as a sample is collected. The screen embodiment prevents debris such as leaves and sticks, from entering and fouling the mechanism.

In some embodiments of the invention, a nesting mechanism is secured to the ground at the site of collection using anchors such as stakes or pegs. The nesting mechanism has a sleeve which accepts the clear container and positions the open distal end of the lip portion at the desired elevation above ground level.

Ideally, the sleeve portion is additionally equipped with a mechanism to secure the clear container so that it doesn't “float” when the runoff occurs. The mechanism to secure the clear container is configured to easily release the clear container and includes a variety of mechanisms obvious to those of ordinary skill in the art including, but not limited to, rubber gaskets and flexible fingers.

The invention, together with various embodiments thereof, will be more fully explained by the accompanying drawings and the following descriptions thereof.

### DRAWINGS IN BRIEF

FIGS. 1A and 1B illustrate the collection vessel of the present invention.

FIGS. 2A and 2B illustrate the pressure vessel being inserted into the nesting mechanism.

FIG. 3 illustrates an alternative nesting mechanism.

FIG. 4 is a top view of the preferred shape for the nesting mechanism.

FIGS. 5A and 5B illustrate and embodiment in which the collection vessel locks into the nesting mechanism.

### DRAWINGS IN DETAIL

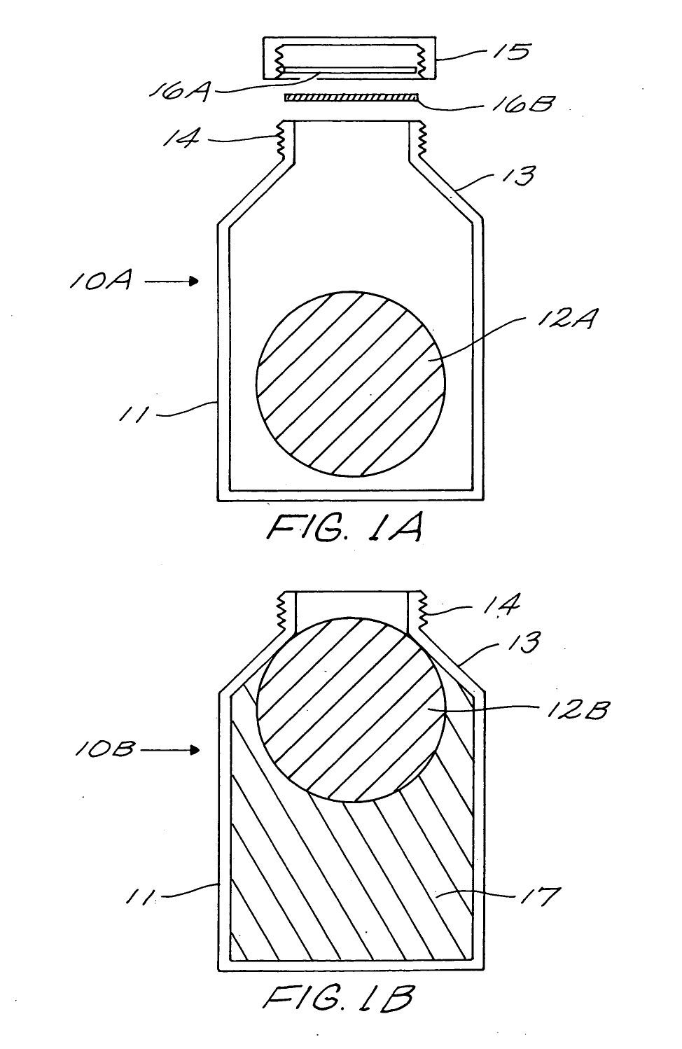

FIGS. 1A and 1B illustrate the collection vessel of the present invention.

Referring to FIG. 1A, the clear container 10A includes a main body 11 made ideally of plastic or glass. Main body 11 is connected to lip portion a lip portion 14 via shoulder portion 13. Main body 11 has a greater diameter than the diameter of lip portion 14.

In the preferred embodiment, lip portion 14 is threaded allowing cap 15 to be selectively affixed thereto. In some embodiments, cap 15 is not solid but is ring shaped allowing an insert/inner saucer 16A to be placed between cap 15 and lip portion 14 to form a seal thereto.

Another embodiment uses a filter or screen 16 as an inner saucer. This embodiment is used to prevent leaves and sticks from entering the clear container 10A during the sampling process. Leaves and sticks could foul the mechanism so that proper sampling is not conducted. Only the first runoff is to be collected so that an accurate analysis is made.

Contained within main body 11 is stopper mechanism 12A. Stopper mechanism 12A has a diameter between the diameter of the main body 11 and the diameter of lip portion 14. Stopper mechanism 14 is a spherical member which floats on water 17 (FIG. 1B) and rises to form a seal between shoulder portion 12B and stopper mechanism 12B. In this manner, the first runoff is collected and “sealed” so that proper analysis can be made.

Ideally, when stopper mechanism 12B has formed the seal, the top of stopper mechanism 12B is extends past the distal lip of lip portion 14; thereby allowing cap 15 to be secured to lip portion 14 without disturbing stopper mechanism 12B.

In this manner, the initial runoff is collected and then secured for historical records as required by law or to create documentation for liability purposes.

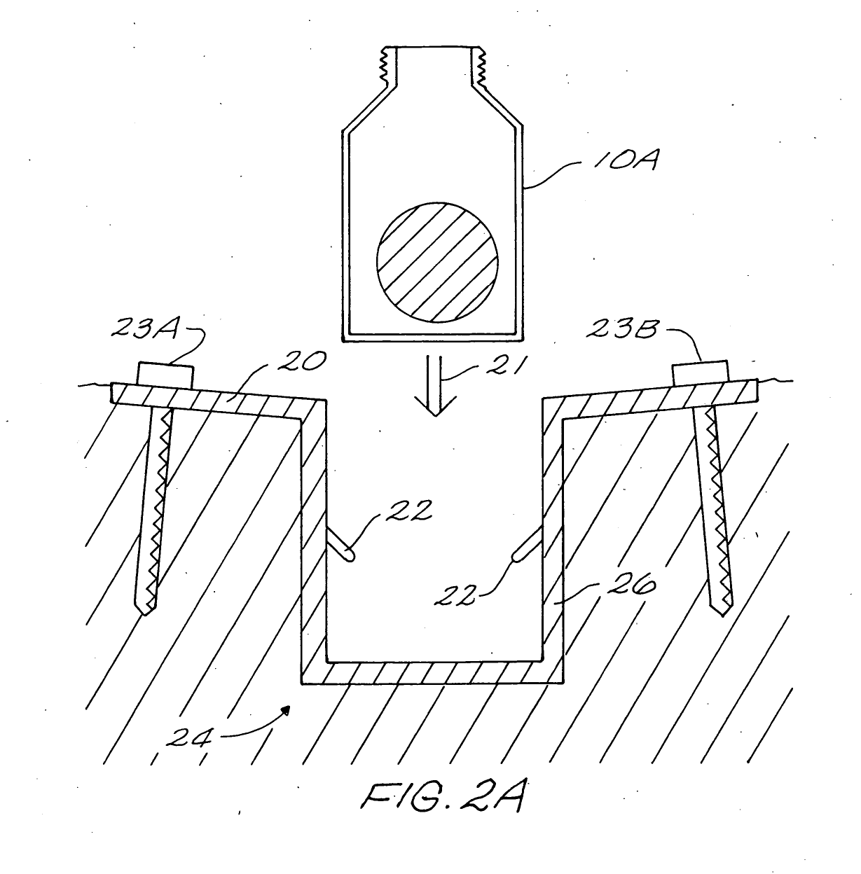

FIGS. 2A and 2B illustrate the pressure vessel being inserted into the nesting mechanism.

The nesting mechanism 20 is placed in the flow path 24 so that runoff will run over it. This establishes the collection site. Nesting mechanism is ideally secured to flow path/soil 24 via stakes 23A and 23B.

Clear container 10A is inserted into receptacle 26 as indicated by arrow 21. During insertion of clear container 10A, fingers 22 are pressed downward as shown in FIG. 2B. Fingers 22 press against the sides of clear container 10A so that as runoff occurs, clear container 10A does not float but is secured so that the proper collection is done.

Receptacle 26 has a depth such that the distal end 27 of lip portion 14 is positioned a height D, 25, above the ground level. Height D 25 is chosen to meet the specific requirements of the site. As example, in certain situations, height D is substantially zero so that even a modest amount of runoff causes collection; in other applications, height D is greater so that only when there is a significant amount of runoff will clear container 10A operate to collect the runoff as outlined above.

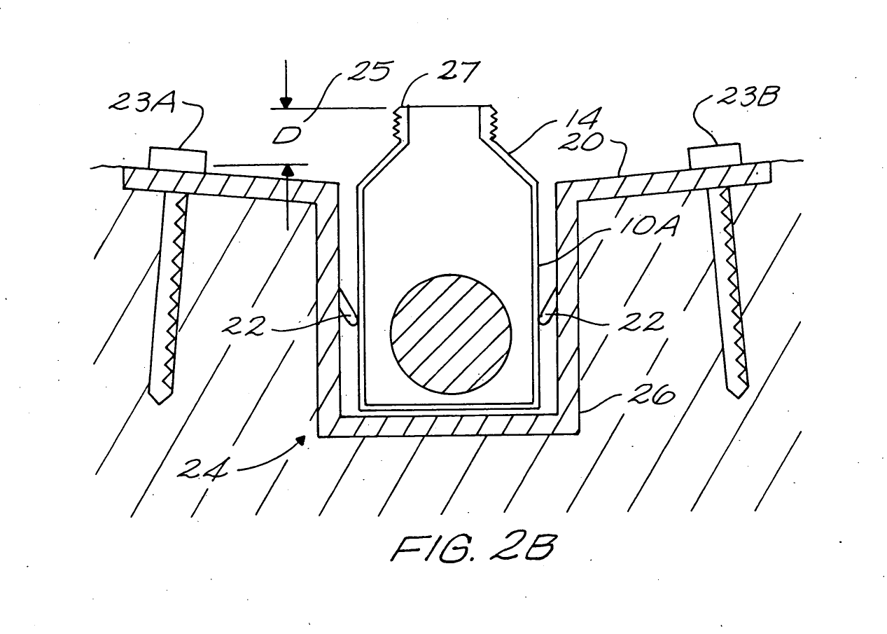

FIG. 3 illustrates an alternative nesting mechanism. Receptacle 26 of this embodiment utilizes a rubber ring 30 which is secured to the walls of receptacle 26. Rubber ring 30 is configured to press against the exterior of the clear container (not shown) and form a frictional bond thereto to prevent floating of the clear container during the collection process.

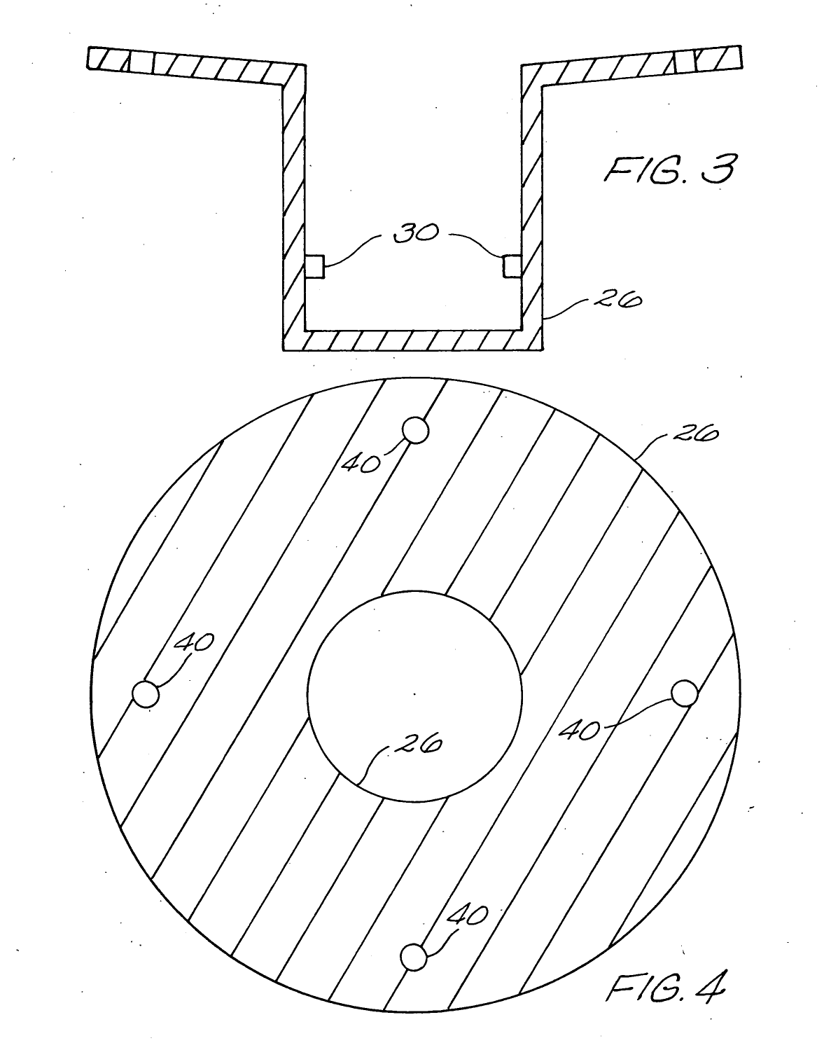

FIG. 4 is a top view of the preferred shape for the nesting mechanism. In this illustration, nesting mechanism 26 is generally circular in shape with receptacle positioned substantially at the center thereof. Holes 40 allow stakes to be driven through nesting mechanism 26 to secure the nesting mechanism to the ground.

Although this embodiment is circular, the invention is not intended to be so limited and includes a variety of other shapes including square, oval, and even triangular.

Ideally, nesting mechanism 26 is brightly colored so that it can be easily found by a user for the replacement of the clear container (not shown) once the sample has been taken.

While nesting mechanism 26 may be made of any material such as plastic, the ideal material is heavy, such as steel, to further restrict the entire assembly from floating or being pushed downstream by the runoff.

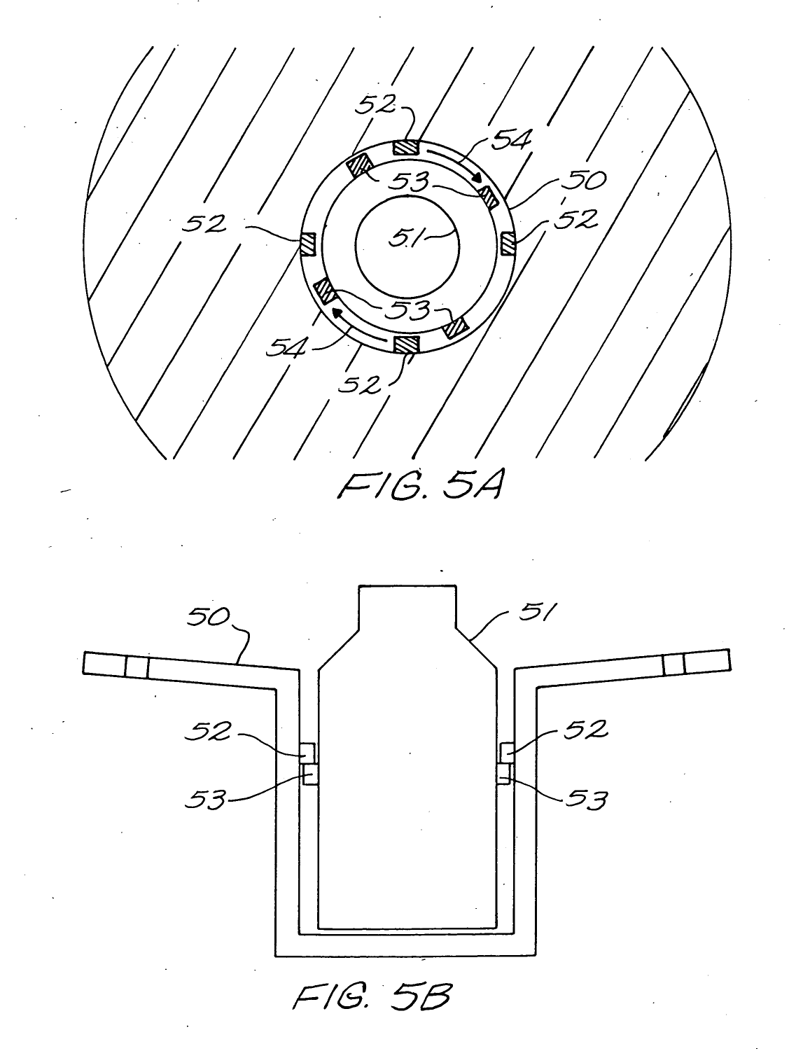

FIGS. 5A and 5B illustrate and embodiment in which the collection vessel locks into the nesting mechanism.

Nesting mechanism 50 with protrusions 52 extending into the hollow cavity; clear container 51 rests within the cavity with protrusions 53 extending therefrom. When clear container 51 is rotated as indicated by arrows 54, protrusions 53 are positioned below protrusions 52, thereby locking the clear container 51 within the nesting mechanism 50.

It is clear that the present invention provides for an effective mechanism to sample the first runoff from a site, allowing the collected water to be proper analyzed.

What is claimed is:

1. A water sampling mechanism comprising:
a) a clear container having a main body connected to a lip portion via a shoulder portion, said lip portion having an open distal edge, said main body having a diameter greater than a diameter of the lip portion;
b) a stopper mechanism contained within said main body, said stopper mechanism having a diameter greater than the diameter of the lip portion and less than the diameter of the main body, said stopper mechanism having a density such that said stopper mechanism floats in water such that said stopper mechanism, at a floating closed position, water cannot enter the clear container.

2. The water sampling mechanism according to claim 1,
a) wherein said lip portion has a generally circular cross-section; and,
b) wherein said stopper mechanism is spherical in shape.

3. The water sampling mechanism according to claim 2, wherein, when said stopper mechanism is positioned at the floating closed position, none of said stopper mechanism extends past the distal edge of said lip portion.

4. The water sampling mechanism according to claim 3,
a) wherein said lip portion includes threads; and,
b) further including a cap mechanism adapted to be secured to said lip portion via the threads.

5. The water sampling mechanism according to claim 4, wherein said cap mechanism includes an outer ring being securable to the threads and an inner saucer configured to be secured between the outer ring and the distal edge of said lip portion.

6. The water sampling mechanism according to claim 5, wherein said inner saucer is porous to water.

7. The water sampling mechanism according to claim 5, wherein said inner saucer is impermeable to water.

8. The water sampling mechanism according to claim 4, further including a nesting mechanism configured to accept the clear container such that, when said nesting mechanism is placed at a collection site at ground level and the clear container is placed therein, the distal edge of said lip portion is positioned at a desired height above ground level.

9. The water sampling mechanism according to claim 8, wherein said nesting mechanism is colored with an identifiable color.

10. A water sampling mechanism comprising:
a) a clear container having a main body connected to a lip portion via a shoulder portion, said lip portion having an open distal edge, said main body having a diameter greater than a diameter of the lip portion, said lip portion having a generally circular cross section;
b) a spherically shaped stopper mechanism adapted to float on water and contained within said main body, said stopper mechanism having a diameter greater than the diameter of the lip portion.

11. The water sampling mechanism according to claim 10, wherein, when said stopper mechanism is positioned at the floating closed position, none of said stopper mechanism extends past the distal edge of said lip portion.

12. The water sampling mechanism according to claim 11,
a) wherein said lip portion includes threads; and,
b) further including a cap mechanism adapted to be secured to said lip portion via the threads.

13. The water sampling mechanism according to claim 12, further including a nesting mechanism configured to accept the clear container such that, when said nesting mechanism is placed in a collection site at ground level and the clear container is placed therein, the distal edge of said lip portion is positioned at a desired height above ground level.

14. A water sampling assembly comprising:
a) a clear container having a main body connected to a generally circular lip portion via a shoulder portion, said lip portion having an open distal edge and being threaded on an exterior surface, said clear container having a diameter greater than a diameter of the lip portion;
b) a spherical stopper mechanism adapted to float and contained within said clear container, said spherical stopper mechanism having a diameter greater than the diameter of the lip portion, said spherical stopper mechanism capable of substantially sealing against the lip portion when said clear container is filled with water; and,
c) a cap mechanism adapted to be secured to said lip portion via the threads.

15. The water sampling assembly according to claim 14, wherein said cap mechanism includes:
a) an outer ring being securable to the threads; and,
b) an inner saucer configured to be secured between the outer ring and the distal edge of said lip portion.

16. The water sampling assembly according to claim 15, further including a nesting mechanism configured to accept the clear container such that, when said nesting mechanism is placed in a collection site at ground level and the clear container is placed therein, the distal edge of said lip portion is positioned at a desired height above ground level.

17. The water sampling assembly according to claim 16, wherein said nesting mechanism includes a releasable catch adapted to secure said clear container therein.

18. The water sampling assembly according to claim 17, further including at least two anchor mechanisms adapted to secure said nesting mechanism to the collection site.

19. The water sampling assembly according to claim 18, wherein said clear container includes a locking mechanism selectively securable to the nesting mechanism.
